(19) United States
(12) Patent Application Publication
(10) Pub. No.: US 2008/0035739 A1
(43) Pub. Date: Feb. 14, 2008

(54) LABEL WITH A RFID TO BE STUCK ON A PRODUCT TO BE FORMED IN A MOLD

(76) Inventor: SHENG-CHANG HUANG, Taliao Town (TW)

Correspondence Address: J.C. Patents, Suite 250, 4 Venture, Irvine, CA, 92618, US

(21) Appl. No.: 11/464,171

(22) Filed: Aug. 11, 2006

(51) Int. Cl. G06K 19/06

(52) U.S. Cl. 235/492

(57) ABSTRACT

A label with RFID to be stuck on a product to be formed in a mold includes a glue film layer and a protective layer. The glue film layer is provided with a radio frequency identification device, and the protective layer is coated with glue or a glue film for not only protecting the RFID but also functioning as a combining medium to permit a label with a RFID stick on a product to be formed in a mold by injecting molding process so that the product can be identified by radio frequency, with the applicable scope of a plastic product widened.

### BACKGROUND OF THE INVENTION

1. Field of the Invention

This invention relates to a label with a radio frequency identification system (RFID) to be stuck on a product to be formed in a mold, particularly to one provided with a glue film layer provided with a RFID and protected by a protective layer of glue, which functions as a combining medium to let the label to stick on a plastic product to be formed in a mold by injecting molding process, so that the product can be identified by radio frequency.

2. Description of Prior Art

The method of identifying commercial goods by radio frequency has gotten popular for speeding up transportation, identification and confirmation of goods, etc. At present, the radio frequency identification chip is coated with a layer of glue for being adhered on a good and then another glue layer is coated on the chip to protect the chip from damaged or scarred.

But this kind of handling process of the radio frequency identification method takes time and needs a rather high cost owing to its complicated operation.

There are some conventional label with a RFID to be stuck on a product to be formed in a mold, such as a Taiwan patent application No. 93127285, a China patent application No. 200410078355, and a U.S. patent application Ser. No. 10/946,795. Some of those cases includes a radio frequency identification chip and an antenna, but the antenna is a line form so that the area to be induced is too small, and the radio frequency identification chip is apt to be hampered or blocked by other things, so it becomes hard to be identified or totally lose its function to be identified.

### SUMMARY OF THE INVENTION

The invention has been devised to offer a label with a RFID to be stuck on a plastic product to be formed in a mold.

The feature of the invention is as follows.
1. The label has a glue film layer, which is provided with a RFID (radio frequency identification system), and a protective layer coated on an outer surface of the glue film layer for protecting the RFID and further functioning as a medium to permit the label stuck on a plastic product to be formed in a mold.
2. The label with a RFID is placed in a mold for forming a plastic product before the product is formed in the mold, and to be stuck on the product during injecting molding process, lessening manufacturing processes of the plastic product.
3. The protecting layer can be a coating of glue or a plastic film.

### BRIEF DESCRIPTION OF DRAWINGS

This invention will be better understood by referring to the accompanying drawings, wherein:

FIG. 1 is an upper view of a first embodiment of a label with a RFID in the present invention;

FIG. 2 is an upper view of the first embodiment of a label with electric lines arranged differently from FIG. 1 in the present invention;

FIG. 3 is a cross-sectional and partly magnified view of the line A-A in FIG. 1;

FIG. 4 is a cross-sectional view of the label with a RFID made in a way in the present invention;

FIG. 5 is a cross-sectional view of the label with a RFID made in another way in the present invention;

FIG. 6 is a cross-sectional and partly magnified view of a second embodiment of a label with a RFID in the present invention;

FIG. 7 is a perspective view of the label with a RFID applied on a kind of goods in the present invention; and,

FIG. 8 is a perspective view of the label with RFIS applied on another kind of goods in the present invention.

### DESCRIPTION OF THE PREFERRED EMBODIMENTS

A first embodiment of a label (A) with RFID (radio frequency identification system) includes a glue film layer 1, a RFID adhered on the surface of the glue film layer 1 and a protective layer 2.

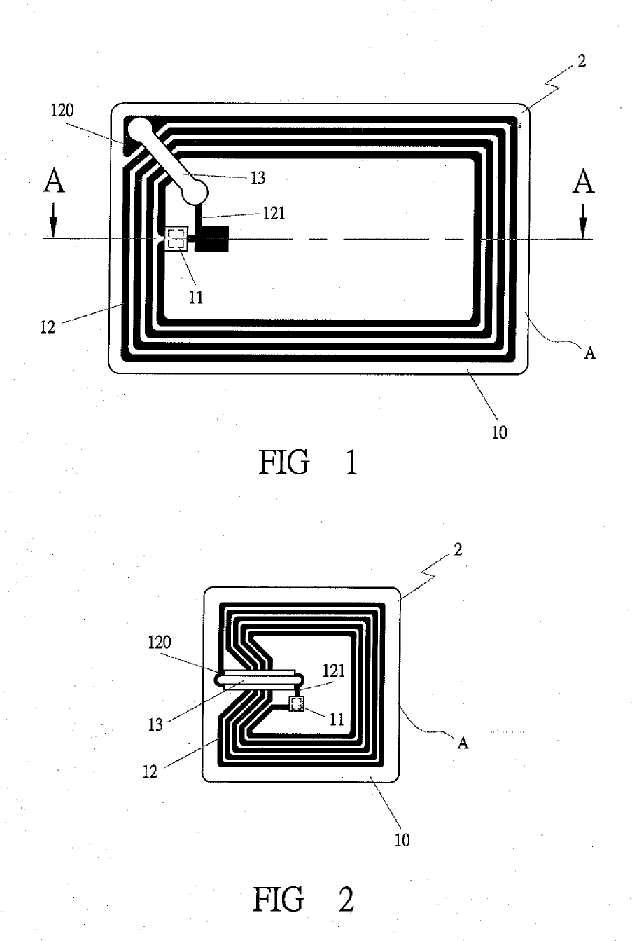

The RFID is composed of a radio frequency identification chip 11 and electric lines 12, which can be made by printing or eroding. The electric lines 12 are intensified in inducing strength by its plural annular shape, and the spreading condition is dependent on the actual demand, as shown in FIGS. 1 and 2, but not limited only in FIGS, 1 and 2. Further, a bridge 13 is provided at the terminal points 120 and 121 of the electric lines 12, permitting the electric lines formed as an annular shape. Then a radio frequency identification chip 11 is connected to a proper point of the lines 12, possible to receive and deal with a wireless signal. The radio frequency identification chip 11 used in the invention may be a ROM chip or a RAM chip, depending on the objective of the invention. Moreover, the glue film layer 1 can printed with decorative patterns, also depending on requirements.

The protective layer 2 is coated on an outer surface of the glue film layer 1, completely hiding the whole surface 10 of the glue film layer 1, functioning as protection for the RFID, The protective layer 2 can be a coating of glue or a plastic film. The objective of the protective layer 2, aside from the protection of the RFID, functions as a medium to permit the label to be stuck firmly on a product 3 to be formed in a mold so that the product may be identified easily.

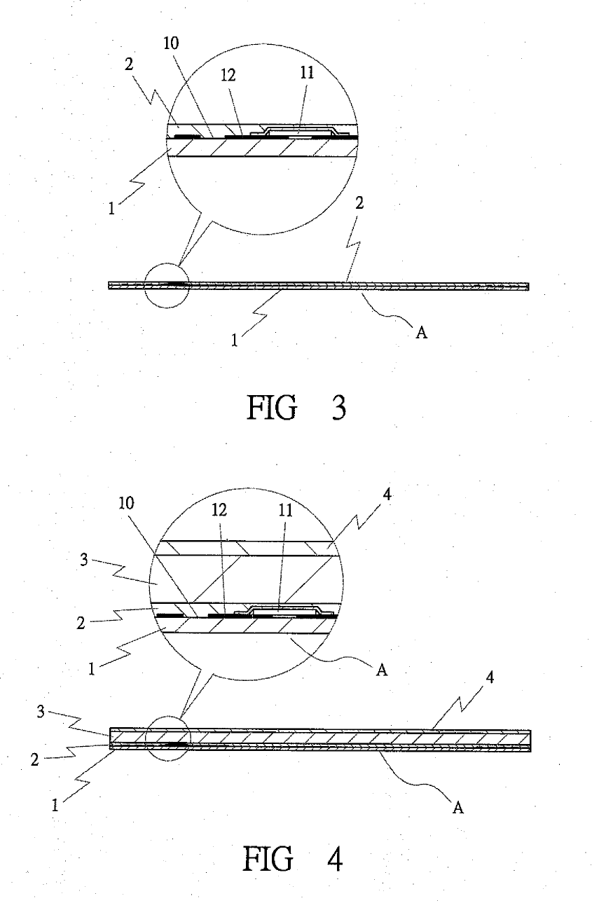

Next, FIG. 4 shows a first method of applying a label on a plastic product 3, and the label (A) with a RFID stuck on one side of the plastic product 3, and another label 4 with a decorative pattern stuck on the other side of the plastic product 3. Further the label 4 can be printed with any characters, patterns to produce adorning effect to the product 3. So the label (A) and the label 4 have to be placed properly in the mold before the product 3 is formed in the mold so that the two labels (A) and 4 can be stuck on the plastic product 3 as integral at the same time during the injecting molding process of the plastic product 3.

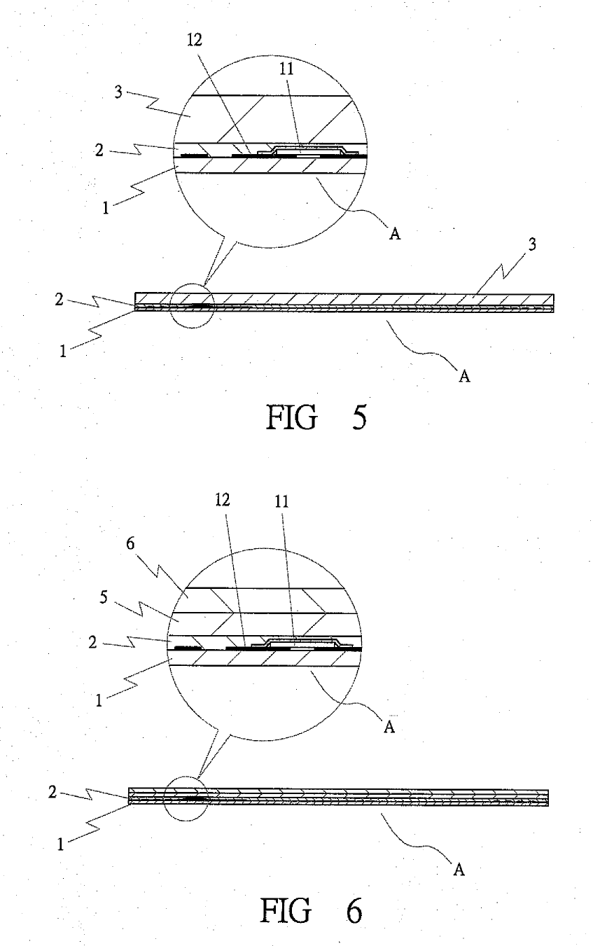

Next, FIG. 5 shows a second method of forming the plastic product with only the label (A), without the label 4. The label (A) has to be placed properly in the mold before the plastic product is to be formed in the mold.

Next, FIG. 6 shows a second embodiment of a label with a RFID to be stuck on a product in the invention, includes a label (A), which is composed of a glue film layer 1, a first protective layer 2, a magnetic material layer 5 and a second protective layer. So the label (A) in the second embodiment has a different structure from that of the first embodiment.

The first protective layer 2 is coated on an outer surface of the glue film layer 1, completely hiding the whole outer surface 10 of the glue film layer 1, protecting properly the RFID. Moreover, the first protective layer may be a coating of glue, adhesive or a plastic film.

The magnetic material layer 5 is coated on the first protective layer 2, made of magnetic material functioning as a metal fence for the label (A), lessening exterior interference on the RFID, enhancing possibility of identification of the RFID.

The second protective layer 6 is coated on the outer surface of the magnetic material layer 5, being a coating of glue or adhesive, or plastic film, depending on the feature of the magnetic material layer 5. In addition, this layer 6 functions as a medium for permitting the label (A) to be properly stuck on a product, enabling the RFID to function well.

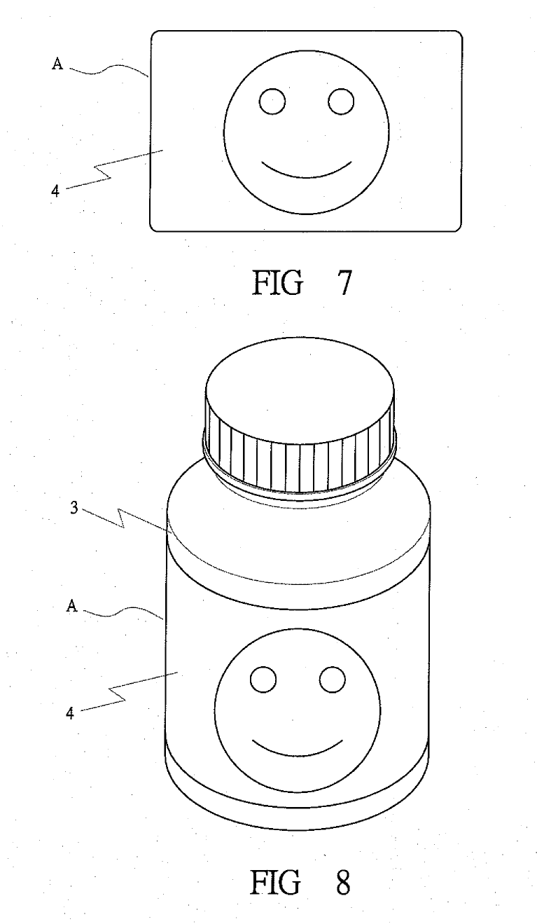

Further FIGS. 7 and 8 show applicable examples 1 and 2 of the label used on. The first example 1 is a most common IC card usable as a ticket card or a travel card. The second example 2 is solid plastic products, such as plastic bottles, cups, cans or containers, applicable to the first method shown in FIG. 4 or the second method shown in FIG. 5. If the first method of FIG. 4 is used, the decorative label 4 is stuck on one side and the label (A) is stuck on the other side of a product 3. Then the product 3 has both a radio frequency identification effect and a beautifying effect. If the second method is used, the product has only the RFID for identifying the person owning the card.

Besides, the product of the second applicable example 2 is suggested to use the second method shown in FIG. 5, with the label (A) only stuck on the product 3.

Moreover, the applicable examples 1 and 2 shown in FIGS. 7 and 8 can use the label (A) of the first embodiment shown in FIGS. 1, 2 and 3 or 6. Specially, the label (A) shown in FIG. 2 has the magnetic material layer 5, which can function as a metal fence for reducing exterior signal interference to upgrade capability of identification. The common IC card or the ticket card, or the travel card as shown in the first applicable example 1 can have an IC chip on one side, or another electronic communication system and then one more IC chip provided on the other side of the IC card, upgrading its value. Or as described in the second applicable example 2, if the contents of the plastic product is magnetic or electric material, or the label is directly stuck on a metal goods, then the second embodiment of the label with the metal fence shown in FIG. 6 can be used for reducing external interference to the RFID. Then though the plastic product is filled with magnetic or electrical contents, the RFID cannot be impaired in its identifying function, with the applicable scope widened. Aside from that the second embodiment can be used for the applicable examples 1 and 2, the plastic product can use the second embodiment for coping with an environment interfered by large magnetism or electrical inductance. Therefore, plastic products with the label in the invention can hold the capability of the RFID under any environment, enhancing its usability.

While the preferred embodiments of the inventin have been described above, it will be recognized and understood that various modifications may be made therein and the appended claims are intended to cover all such modifications that may fall within the spirit and scope of the invention.

1. A label with a RFID to be stuck on a product to be formed in a mold, said label comprising:
a glue film layer provided with a RFID (radio frequency identification system), said RAID consisting of a radio frequency identification chip and electric lines; and,
a protective layer coated on an outer surface of said RFID of said glue film layer and hiding the whole surface of said glue film layer for protecting said RFID, said protective layer further functioning as a medium to let said label to be stuck on a plastic product to be formed in a mold.

2. The label with RFID as claimed in claim 1, wherein said protective layer is a coating of glue.

3. The label with RFID as claimed in claim 1, wherein said protective layer is a plastic film.

4. The label with RFID as claimed in claim 1, wherein said electric lines are shaped plural rings.

5. The label with RFID as claimed in claim 1, wherein said electric lines of said RFID is combined with a bridge, which makes said lines as an annular passageway.

6. The label with RFID as claimed in claim 1, wherein said plastic film layer is printed with decorative patterns.

7. A plastic product with a label having a RFID, said plastic product stuck with a label containing a RFID on one side and another decorative label stuck on another side, said decorative label printed with any characters and patterns.

8. A plastic product with a label having a RFID, said product stuck with a label on one side, said label provided with a RFID.

9. The plastic product with a label having a RFID as claimed in claim 7, wherein said label has a plastic film layer printed with decorative patterns.

10. A label with a RFID to be stuck on a product to be formed in a mold, said label comprising:
A glue film layer provided with a RFID, which consists of a radio frequency identification chip and electric lines;
A first protective layer coated on an outer surface of said RFID of said glue film layer, said first protective layer hiding the whole surface of said glue film layer for protecting said RFID;
A magnetic material layer coated on an outer surface of said first protective layer, said magnetic material layer functioning as a metal fence to reduce interference of external miscellaneous signals;
A second protective layer coated on an outer surface of said magnetic material layer to function as a medium for permitting said label to stick on a product to be formed in a mold.

11. The label as claimed in claim 10, wherein said first protective layer is a coating of glue,

12. The label as claimed in claim 10, wherein said second protective layer is a coating of glue.

13. The label as claimed in claim 10, wherein said first protective layer is a plastic film.

14. The label as claimed in claim 10, wherein said second protective layer is a plastic film.

15. The plastic product with a label having a RFID as claimed in claim 8, wherein said label has a plastic film layer printed with decorative patterns.
